(19) United States
(12) Patent Application Publication
(10) Pub. No.: US 2026/0054540 A1
(43) Pub. Date: Feb. 26, 2026

(54) COLD AIR DUCT AND VEHICLES INCLUDING SAME

(71) Applicant: Toyota Motor North America, Inc., Plano, TX (US)

(72) Inventors: Stephen E. Freeman, McKinney, TX (US); Jakin C. Wilson, Prosper, TX (US)

(73) Assignees: Toyota Motor North America, Inc., Plano, TX (US); Toyota Jidosha Kabushiki Kaisha, Toyota-shi (JP)

(21) Appl. No.: 18/814,936

(22) Filed: Aug. 26, 2024

(51) Int. Cl. B60H 1/00

(52) U.S. Cl. CPC B60H 1/00564; B60H 1/00664

(57) ABSTRACT

A method of providing cooling air to air surrounding an airbox of a vehicle is provided. The method includes connecting an inlet end of a cold air duct to a cold air opening at a front of the vehicle such that the cold air duct receives ambient air surrounding the vehicle through the inlet end. An outlet end of the cold air duct is located adjacent a casing of the airbox such that there is a gap between the outlet end and the casing. During vehicle operation, the ambient air entering the cold air duct through the inlet end is directed toward the airbox through the cold air duct and exits the outlet end into the gap, cooling air surrounding the airbox.

### TECHNICAL FIELD

The present specification generally relates to air intake systems for vehicles, and more specifically, air intake systems with cold air ducts and vehicles that include such cold air ducts.

### BACKGROUND

Combustion engines for vehicles need air for their combustion processes. Ambient air can enter an engine compartment through the front of the vehicle, passing through a front grille and flowing past a radiator. However, the radiator can heat the air passing therethrough, which can reduce the volumetric efficiency and output power of the engine.

Accordingly, other improved air intake systems are desired that can take advantage of cooler ambient air.

### SUMMARY

In one embodiment, a method of providing cooling air to air surrounding an airbox of a vehicle is provided. The method includes connecting an inlet end of a cold air duct to a cold air opening at a front of the vehicle such that the cold air duct receives ambient air surrounding the vehicle through the inlet end. An outlet end of the cold air duct is located adjacent a casing of the airbox such that there is a gap between the outlet end and the casing. During vehicle operation, the ambient air entering the cold air duct through the inlet end is directed toward the airbox through the cold air duct and exits the outlet end into the gap, cooling air surrounding the airbox.

In another embodiment, a vehicle includes a vehicle body that includes an engine compartment. An engine is located in the engine compartment. An air intake system includes an airbox and an air intake duct assembly including an inlet end connected to an intake opening at a front of the vehicle body and an outlet end connected to the airbox at an inlet. An outlet duct is connected to the airbox that is operatively connected to the engine for delivering filtered air to the engine from the airbox. A cold air duct includes an inlet end that is connected to a cold air opening at the front of the vehicle body. An outlet end of the cold air duct is located adjacent the airbox such that ambient air entering the cold air duct through the inlet end being directed toward the airbox through the cold air duct and exiting the outlet end into a gap between the outlet end and the airbox and cooling air surrounding the airbox during operation of the vehicle.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a portion of an engine compartment of a vehicle that includes an air intake system and a cold air duct, according to one or more embodiments shown or described herein;

FIG. 2 schematically depicts a front view of a portion of the vehicle of FIG. 1 including the air intake system and cold air duct, according to one or more embodiments shown and described herein;

FIG. 3 is a side view of a portion of the engine compartment of FIG. 1 showing the air intake system and cold air duct, according to one or more embodiments shown and described herein; and

FIG. 4 shows the cold air duct of FIG. 1 in isolation, according to one or more embodiments shown and described herein.

### DETAILED DESCRIPTION

Vehicles according to the present specification include vehicles that include an air intake system in an engine compartment of the vehicles that provides air to an intake manifold of an engine of the vehicles. The air intake system includes an air intake duct assembly that may include a snorkel and an intake duct. The snorkel is in fluid communication with an intake opening at a front of the vehicles through which ambient air can enter the snorkel. The intake duct extends from the snorkel to an airbox. The airbox includes a filter that is used to filter the incoming air. An outlet duct extends from the airbox to an intake manifold of the engine where the air enters the engine to begin and/or maintain a combustion process to produce power for the vehicles. A cold air duct is provided that includes an inlet end that is in fluid communication with a cold air opening at the front of the vehicles. The cold air duct extends from the inlet end to an outlet end that is located adjacent a casing of the airbox. The outlet end is not connected directly to the airbox. Instead, the cold air duct delivers ambient air to air surrounding the airbox, which can improve air intake temperatures by lowering them.

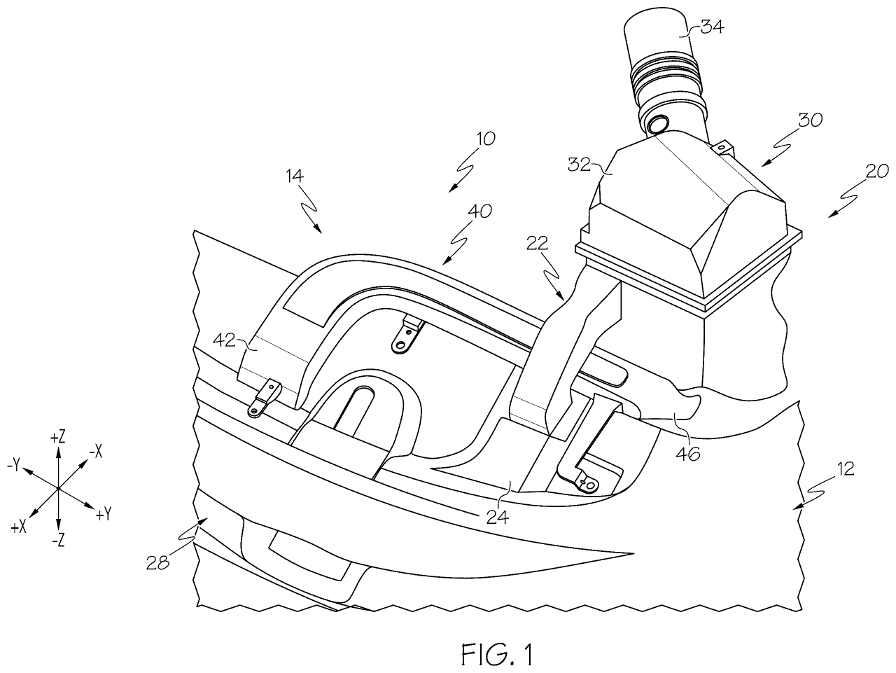

As used herein, the term “vehicle longitudinal direction” refers to the forward-rearward direction of the vehicle 10 (i.e., in the +/− vehicle X-direction depicted in FIG. 1). The term “vehicle lateral direction” refers to the cross-vehicle direction (i.e., in the +/− vehicle Y-direction depicted in FIG. 1), and is transverse to the vehicle longitudinal direction. The term “vehicle vertical direction” refers to the upward-downward direction of the vehicle 10 (i.e., in the +/− vehicle Z-direction depicted in FIG. 1). Further, the terms “inboard,” “inward,” “outboard” and “outward” are used to describe the relative positioning of various components of the vehicle. Referring to FIG. 1, the terms “outboard” or “outward” as used herein refers to the relative location of an outward component away from a vehicle centerline. The term “inboard” or “inward” as used herein refers to the relative location of an inward component toward the vehicle centerline. Because the vehicle structures may be generally symmetrical about the vehicle centerline, the direction to which use of terms “inboard,” “inward,” “outboard” and “outward” refer may be mirrored about the vehicle centerline when evaluating components positioned along opposite sides of the vehicle 10.

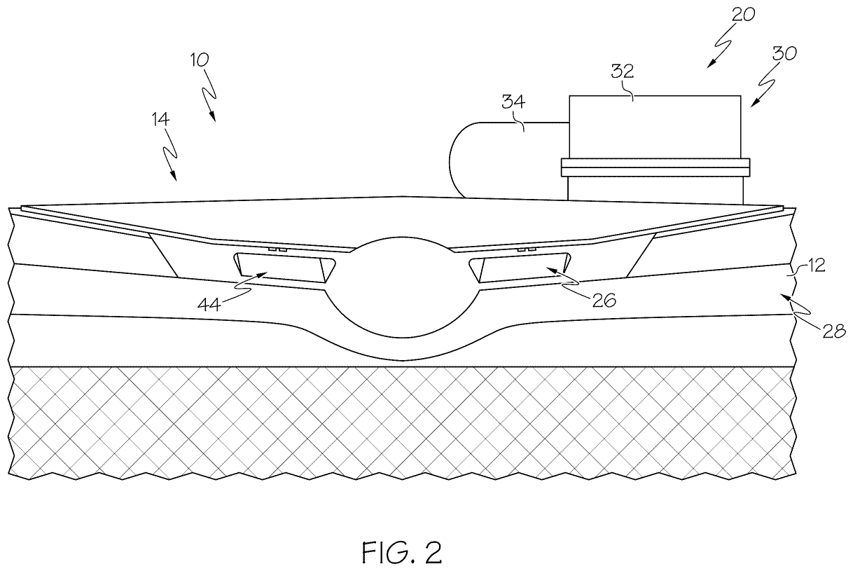

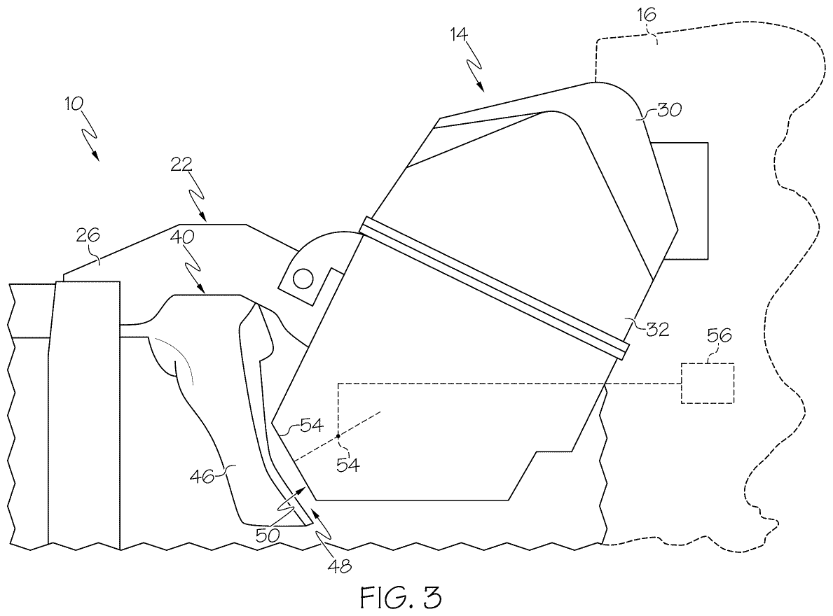

Referring to FIGS. 1-4, a vehicle 10 includes a vehicle body 12 and an engine compartment 14 with a combustion engine 16 (FIG. 3) located therein that is configured to generate power for driving the vehicle 10. An air intake system 20 is configured to provide air to the combustion engine 16 for use in a combustion process during operation of the combustion engine 16. The air intake system 20 includes an air intake duct assembly 22 that may include a snorkel 24 and an intake duct 26. The snorkel 24 is a component that accesses ambient air at a front of the vehicle 10. The snorkel 24 is in fluid communication with an intake opening 26 (FIG. 2) at a front 28 of the vehicle 10 through which ambient air can enter the snorkel 24. The intake duct 26 extends from the snorkel 24 to an airbox 30. The airbox 30 includes a filter inside a casing 32 of the airbox 30 that is used to filter the incoming air before the air enters the combustion engine 16. An outlet duct 34 extends from the airbox 30 to an intake manifold of the combustion engine 16 where the air enters the combustion engine 16 to begin and/or maintain a combustion process to produce power for the vehicle 10.

A cold air duct 40 is provided that includes an inlet end 42 that is in fluid communication with a cold air opening 44 (FIG. 2) at the front 28 of the vehicle 10. As can be seen in FIG. 2, the cold air opening 44 extend through the vehicle body 12 so that ambient air surrounding the vehicle can directly enter the cold air duct 40 though the opening The cold air duct 40 extends from the inlet end 42 to an outlet end 46 that is located adjacent the casing 32 of the airbox 30. The outlet end 46 is not connected directly to the airbox 30 in that the cold air duct 40 terminates before it reaches the casing 32 providing a gap 48 between the outlet end 46 and the casing 32 (FIG. 3). The cold air duct 40 delivers ambient air to air surrounding the airbox 30, which can improve air intake temperatures by lowering them to temperatures below that which would be present if the cold air duct 40 was not present. Cooler air can result in denser air and an increased amount of oxygen molecules, which can improve fuel efficiency and engine performance.

Referring to FIG. 3, in some embodiments, the airbox 30 may include a secondary inlet 50. In this example, the secondary inlet 50 is located at a bottom side corner 52 of the casing 32, adjacent the outlet end 46 of the cold air duct 40. A door 54 (e.g., a vane) may be connected to the casing 32 (e.g., by a hinge or any other suitable connection, such as sliding). Under high load conditions when the combustion engine 16 tends to heat up (e.g., between about 75 percent and about 100 percent of the engine capacity), the door 54 may move from a closed position to an open position, represented by dashed lines. In the open position, the cooler air provided from the outlet end 46 of the cold air duct 40 can enter directly into the airbox 30, improving intake temperatures and air volume. In some embodiments, an actuator 56 may be operatively connected to the door 54 and a vehicle ECU, which can be used to control the actuator based on a detected engine load. In other embodiments, the door 54 may be spring-biased toward the closed position with a spring force that can be overcome by the cooler air exiting the cool air duct under high vehicle accelerations and velocities that are indicative of high load conditions.

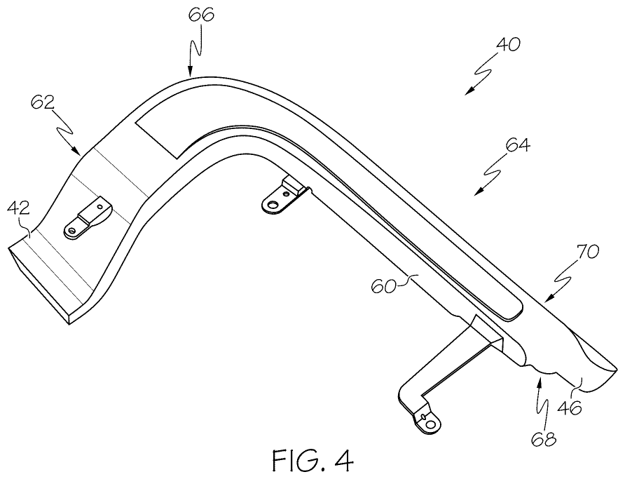

FIG. 4 illustrates the cold air duct 40 in isolation. The cold air duct 40 includes the inlet end 42, the outlet end 46 and a duct body 60 that extends between the inlet end 42 and the outlet end 46. The duct body 60 has a longitudinally-extending portion 62 and a laterally-extending portion 64 that extends laterally from the longitudinally-extending portion 62 at a bend 66. As can be seen in FIG. 1, the laterally-extending portion 64 extends laterally beneath the intake duct 26 toward the airbox 30. A vertically-extending portion 68 extends down from the laterally-extending portion 64 at another bend 70 to position the outlet end 46 adjacent the secondary inlet 50. The cold air duct 40 may include various mounting locations for mounting the cold air duct within the engine compartment 14 at the desired location. It should be noted that the shape of the cold air duct 40 may follow any suitable path and may depend on the space constraints and positioning of components within the engine compartment 14.

The above-described air intake systems include a cold air duct that delivers cooler ambient air to the environment surrounding the airbox. Delivering the cooler ambient air to the airbox surroundings can lower the intake air temperature, increasing density and oxygen content of the intake air thereby improving engine performance. The cold air duct is not connected directly to the airbox, which can provide for a variety of design possibilities for a particular engine compartment architecture. No direct connection to the airbox can avoid the need to filter the cooler air under normal operating conditions. Under high load conditions, a secondary inlet to the airbox may open to allow the cooler air to enter the airbox. Should this occur, the airbox filter can filter the cooler air that mixes with the intake air inside the airbox.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method of providing cooling air to air surrounding an airbox of a vehicle, the method comprising:
connecting an inlet end of a cold air duct to a cold air opening at a front of the vehicle such that the cold air duct receives ambient air surrounding the vehicle through the inlet end; and
locating an outlet end of the cold air duct adjacent a casing of the airbox such that there is a gap between the outlet end and the casing wherein, during vehicle operation, the ambient air entering the cold air duct through the inlet end being directed toward the airbox through the cold air duct and exiting the outlet end into the gap and cooling air surrounding the airbox.

2. The method of claim 1 further comprising providing the casing of the airbox with a secondary inlet that is positioned adjacent the outlet end of the cold air duct.

3. The method of claim 2 further comprising providing a door configured to cover the secondary inlet in a closed position.

4. The method of claim 3 further comprising opening the door to an open position during vehicle operation.

5. The method of claim 4, wherein the step of opening the door includes opening the door with an engine of the vehicle operating under a high load condition.

6. A vehicle comprising:
a vehicle body that includes an engine compartment;
an engine located in the engine compartment;
an air intake system comprising:
an airbox;
an air intake duct assembly including an inlet end connected to an intake opening at a front of the vehicle body and an outlet end connected to the airbox at an inlet; and
an outlet duct connected to the airbox that is operatively connected to the engine for delivering filtered air to the engine from the airbox; and
a cold air duct comprising:
an inlet end that is connected to a cold air opening at the front of the vehicle body; and
an outlet end that is located adjacent the airbox such that ambient air entering the cold air duct through the inlet end being directed toward the airbox through the cold air duct and exiting the outlet end into a gap between the outlet end and the airbox and cooling air surrounding the airbox during operation of the vehicle.

7. The vehicle of claim 6, wherein the airbox comprises a casing that includes a secondary inlet that is positioned adjacent the outlet end of the cold air duct.

8. The vehicle of claim 7, wherein the airbox further comprises a door configured to cover the secondary inlet in a closed position, the door configured to move to an open position.

9. The vehicle of claim 7 further comprising an actuator that is configured to move the door with the engine under a high load condition.

10. The vehicle of claim 6, wherein the cold air duct extends from the inlet end and laterally beneath the air intake duct to the gap.
